(19) United States
(12) Patent Application Publication
(10) Pub. No.: US 2011/0036226 A1
(43) Pub. Date: Feb. 17, 2011

(54) Insert, support, tool and method

(76) Inventor: Iian Cohen, Moshav (IL)

Correspondence Address: Steven W. Weinrieb;LAW OFFICES OF STEVEN W. WEINRIEB, 8717 Cold Spring Road, Potomac, MD, 20854, US

(21) Appl. No.: 12/805,699

(22) Filed: Aug. 16, 2010

Related U.S. Application Data
(60) Provisional application No. 61/234,292, filed on Aug. 16, 2009.

(51) Int. Cl. B26D 1/00; B23P 17/04

(52) U.S. Cl. 83/651; 29/428

(57) ABSTRACT

The present disclosure may be primarily concerned with a tool having at least one insert removably mounted on a support plate with the combination removably secured to an at least one seat formed on the tool.

### CROSS-REFERENCE TO RELATED APPLICATIONS

The present application claims priority from Provisional Patent Application No. 61/234,292 filed Aug. 16, 2009 by the named inventor herein entitled Cutting Insert.

### TECHNICAL FIELD

The present disclosure may generally relate to a substrate or support plate for an indexable, and/or optionally reversible (also may be known as invertible, or double-sided) inserts, possibly cutting inserts. The present disclosure may further relate to a combination of such insert, tool, and support plate, and to a method of assembling and employing the combination.

### BACKGROUND

A corresponding support plate, a corresponding cutting insert and also a corresponding tool are known, as an illustrative example only, from DE 196 53 921.

Attention is presently drawn to FIG. 1, titled “Prior Art”, depicting a detail from FIG. 8 in DE 196 53 921. A support plate known from DE 196 53 921 substantially corresponds in its outline shape to an outline of a central plateau (surrounding a fixing bore) of a contact face of an insert; in particular upper edges of the support plate are at a relatively large internal spacing relative to insert edges, which are most closely adjacent thereto, on a side of the insert, that is towards the support plate. The peripheral contour of the insert projects substantially beyond the peripheral contour of the associated support plate.

In comparison with the known state of the art, the object of the present disclosure is to provide a support plate and correspondingly a combinations of support plates and inserts, as well as corresponding tools which may employ such support plates and inserts, and a method employing the same.

### SUMMARY

The present disclosure may generally relate to a tool having at least one location, or seat (which may also be known in the art as a nest, or a pocket), for removably mounting a substrate or support plate for at least one, optionally indexable, and/or optionally reversible (also may be known as invertible, or double-sided) insert, optionally, but not limited to, a cutting insert, which is to be removably located in a tool to be provided with the at least one insert. The support plate may be of any known or discovered configuration, and may provide a bottom contact face which can be placed on a face of the seat, and a top support face which may correspond to, and may carry, a lower surface of the insert. The present disclosure may further relate to a combination of such insert, tool, and support plate, and to a method of assembling and employing the combination.

Possibly, the at least one insert may comprise a plateau which is disposed within the insert edges and at a spacing therefrom and which is defined by one or more contact faces and the insert edges of the insert are at a varying spacing from a notional central plane which separates the two sides of the double-sided insert from each other.

Furthermore, the present disclosure may also concern a corresponding tool which is provided with at least one seat for removably receiving a support plate as well as a combination of a support plate and a cutting insert of the aforementioned kind. In that respect, in an exemplary, illustrative-only embodiment of the disclosure, a support plate for an insert may be provided, which may be removably fixed on a tool, possibly on a seat (which may be also commonly known in the art as a nest, or a pocket, to name a few common phrases), the tool may comprise at least one seat for at least one insert and at least one support plate, the support plate may be provided with a lower support face designed to be removably mounted on the seat, and an upper support face which may removably carry the insert, the insert being provided with at least one working end and the support plate being provided with a generally corresponding at least one active end, wherein a support plateau is distanced from an insert lower plateau, and an at least one support rest abuts a generally corresponding insert lower abutment.

Potentially, the insert may be provided with a transitional support face which, when the insert may be removably installed on the support plate may be distanced from an insert lower transition.

Additionally, the present disclosure may be concerned with a combination of a support plate and an insert, the support plate may be designed to be removably mounted on a seat of a tool and the insert may be designed to be removably mounted on the support plate, the insert may be provided with a plurality of generally similar therebetween working ends and the support plate may be provided with a plurality of generally similar therebetween active ends, each of the plurality of the working ends is similar and corresponds to a respective one of the plurality of the active ends, wherein a support plateau is distanced from an insert lower plateau, and each of a plurality of support rests abuts each of a plurality of a generally corresponding insert lower abutments.

Furthermore, the combination may be concerned with each of a plurality of transitional support faces may be distanced from a corresponding one of a plurality of insert lower transitions.

Potentially, the present disclosure may also be concerned with a method for removably mounting at least one insert to a corresponding at least one seat on a tool, the method comprises steps of providing at least one corresponding support plate and the at least one insert, the at least one support plate may be removably mounted to the at least one seat on the tool; providing a plurality of generally similar therebetween working ends on the at least one insert and a corresponding plurality of generally similar therebetween active ends on the support plate; providing a support plateau on the at least one support plate and an insert lower plateau on the at least one insert; providing a plurality of generally similar therebetween support rests on the at least one support plate and a plurality of generally similar therebetween insert lower abutments each corresponding to one of the plurality of the support rests; and removably mounting the at least one support plate to the at least one seat on the tool, and removably mounting the at least one insert to the removably mounted at least one support plate, so that each of the plurality of insert lower abutments abuts a corresponding one of the plurality of support rests, and so that the support plateau is distanced from the insert lower support.

Possibly, the method may comprise an additional step of providing a plurality of generally similar therebetween transitional support faces on an upper support face of the at least one support plate; providing a plurality of corresponding generally similar therebetween insert lower transitions of the at least one insert, and removably mounting the at least one insert to the at least one support plate, so that each of the plurality of insert lower transitions is distanced from a corresponding support transition faces.

In addition to the exemplary aspects and embodiments described above, further possible aspects and/or embodiments will become apparent by reference to the figures and by study of the following detailed descriptions.

### BRIEF DESCRIPTION OF EXEMPLARY DRAWINGS

Exemplary embodiments are illustrated in referenced figures and drawings . It is intended that the embodiments and figures disclosed herein are to be considered illustrative rather than restrictive. It is emphasized that, according to common practice, the various features of the drawing may not be to scale, but rather dimensions of various features may be arbitrarily expanded or reduced for clarity.

Reference will now be made to the accompanying drawings, in which:

FIG. 1, titled “Prior Art”, illustrates a detail taken from FIG. 8 in DE 196 53 921 showing a combination of a prior-art tool, a prior-art support plate, and a prior-art insert;

FIG. 2 schematically illustrates an exemplary, partial bottom perspective view of an exemplary, illustrative, working end of an exemplary insert of the present disclosure;

FIG. 3 schematically illustrates an exemplary, partial top perspective view of an exemplary, illustrative, active end of an exemplary, illustrative, support plate of the present disclosure;

FIG. 4 schematically illustrates a partial plan view of the active end of the support plate schematically illustrated on FIG. 3;

FIG. 5 schematically illustrates a partial elevation view of the active end of the support plate schematically illustrated on FIG.

FIG. 6 schematically illustrates a partial exploded perspective view of a combination of the exemplary insert and the exemplary support plate; and

FIG. 7 schematically illustrates a sectional view taken along a 7-7 line shown on FIG. 6.

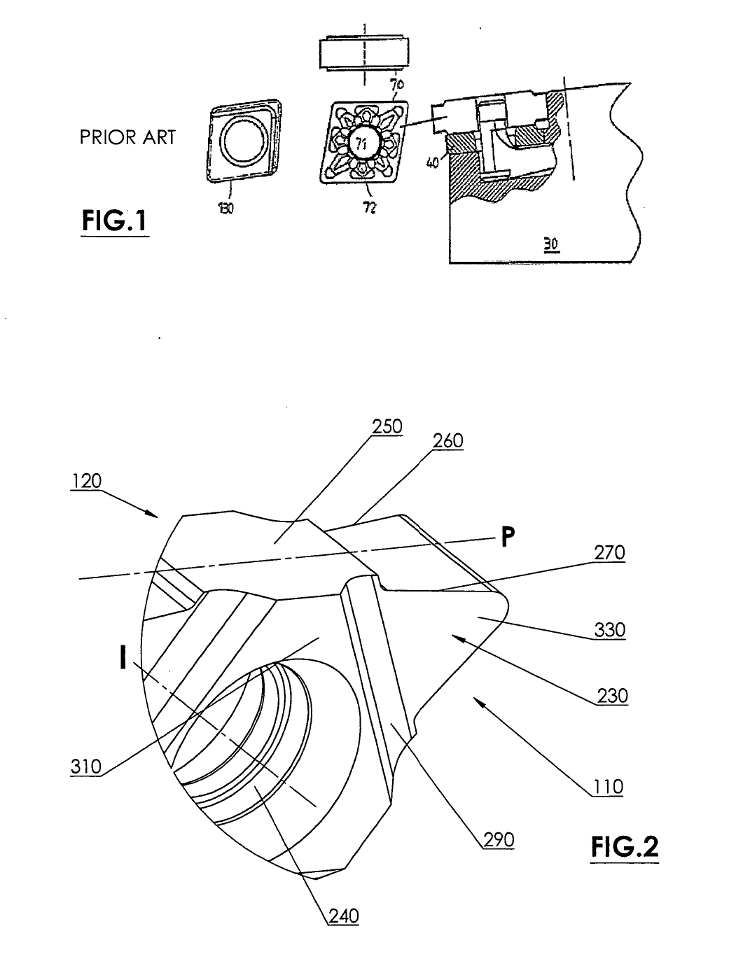

### DETAILED DESCRIPTION

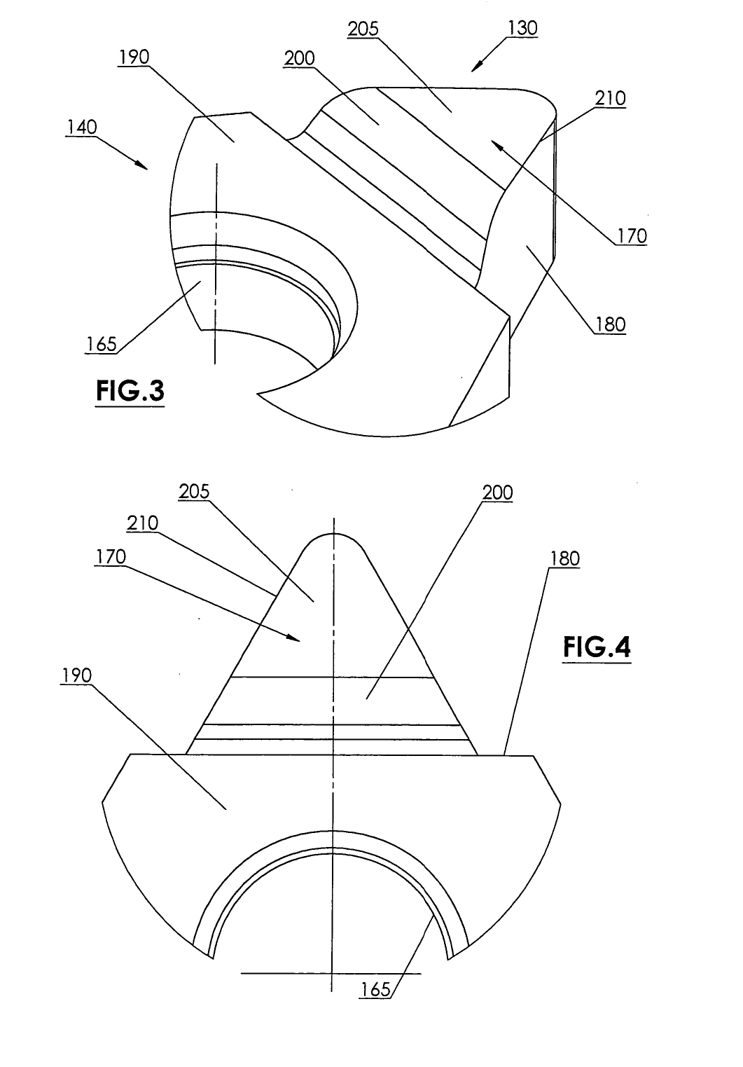

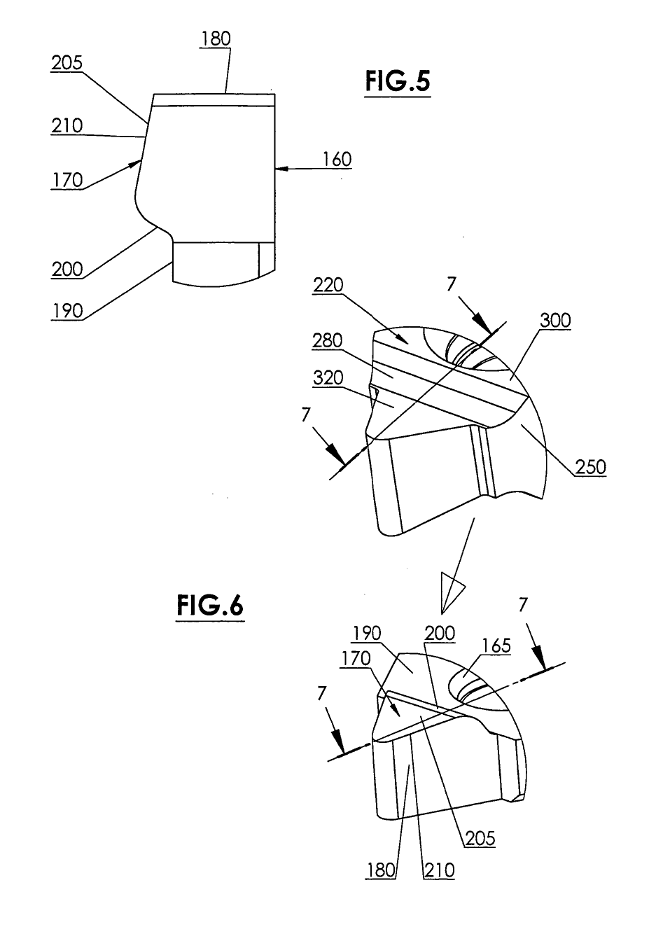

Attention is drawn to FIGS. 2, 3, 4 and 5. FIG. 2 schematically illustrates an insert working end 110 of an exemplary insert 120 according to the present disclosure. FIGS. 3, 4 and 5 schematically illustrate an active end 130 of a support plate 140 which may be fitted on a seat (not shown) which may be formed in and/or on a tool (not shown), and which can be removably fixed in the seat by a fastener (not shown). The insert 120 may comprise a plurality of working ends 110. Similarly, the support plate 140 may comprise a plurality of generally similar, if not absolutely identical, active ends 130, which potentially may match in number the plurality of working ends 110 of the insert 120. The support plate, as well as the insert, may be of any known or discovered basic shape, and of any known or discovered material, to suit the required effect which the tool is designed to achieve. Possibly, the support plate and the insert may conform.

The tool may be of any known or discovered configuration and/or material, and may comprise, among other features, a tool tail (not shown) and a tool head (not shown). The tool tail may be of any known and/or discovered configuration, and may be adapted to a permanent and/or removable attachment to a machine (not shown). The tool head may comprise at least one seat which may accommodate at least one support plate 140 and at least one insert 120.

When removably located in the seat of the tool, a lower support face 160 of the support plate 140 may abut at least a portion of a seat floor (not shown) of a tool (not shown). An upper support face 170 of the support plate 140 may be disposed opposite the lower support face 160, with a peripheral support side 180 extending generally transversely between, and merging with, the upper support face 170 and the lower support face 160. The upper support face 170 may comprise a central support plateau 190 and an adjoining transitional support face 200 which extends between the central plateau 190 and a support rest 205. The support rest 205 may extend from the transitional support face 200 towards an upper rest edge 210 which may be formed a the merge of the peripheral support side 180 and the support rest 205.

A through-bore 165 may extend between, and merge with, the upper and lower faces 170, 160, to facilitate releasable and/or removable clamping on the seat of the tool. The fastener may be of any known or discovered type, including, but not limited to, a bolt or screw, a clamp, and/or a wedge. The support rest 205 may be disposed away from the through-bore 165, towards an outermost region of the upper support face 170.

The insert 120 may be of a symmetrical configuration relative to a central plane P extending generally horizontally and parallel to generally similar, and/or interchangeable, opposing, insert upper face 220 and insert lower face 230. The insert 120 may be formed with an insert through-hole 240 extending between, and merging with, the insert upper and lower faces 220, 230, to facilitate removable clamping in the seat of the tool. The insert 120 may be rotatable about an axis I extending through the through-hole 240 and/or invertible about the central plane P to present a fresh tip, as is well known in the art. The insert 120 may comprise insert peripheral flank 250 extending between, and generally transversely to, the insert upper and lower faces 220, 230 to define insert upper and lower edges 260, 270 at the meeting of the insert upper and lower faces 220, 230 and the insert peripheral flank 250.

The insert 120 features the insert working end 110 adjacent the upper and lower insert edges 260, 270 with insert upper and lower transitions 280, 290 extending towards the insert through-hole 240 and away from insert upper and lower plateaus 300, 310 which surrounds the insert through-hole 240. The insert upper and lower transitions 280, 290 may extend from the insert upper and lower plateaus 300, 310 in a direction away from the insert through-hole 240, towards the upper and lower insert edges 260, 270 to merge with insert upper and lower abutments 320, 330 extending away from the insert upper and lower transitions 280, 290 to the upper and lower edges 260, 270.

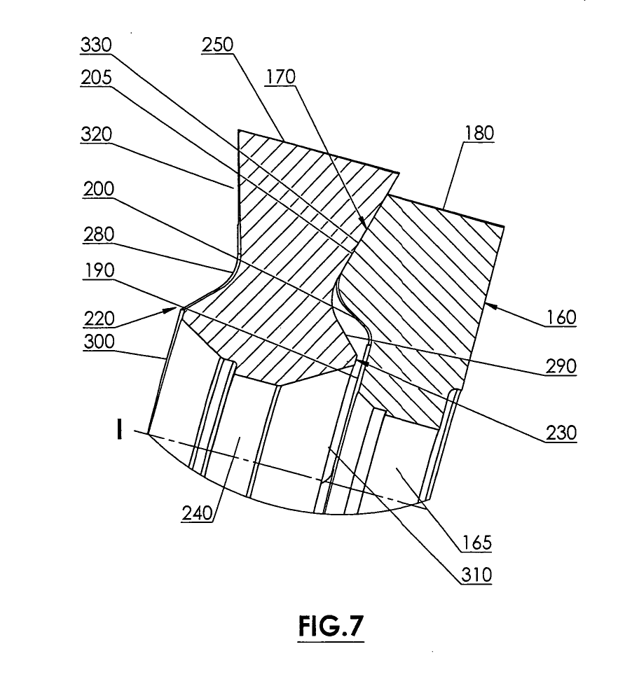

FIGS. 6 and 7 schematically illustrate an assembly drawing showing an exploded view illustrating a partial exemplary insert 120 and a partial exemplary support plate 140 (FIG. 6) and a cross-section taken through the assembly (FIG. 7). As may be seen in FIG. 6, the lower support face 160 may be directed towards the seat (not shown) of the tool (not shown). The upper support face 170 may be directed towards the insert lower face 230 of the removably mounted insert 120, so that the working end 110 of the insert 120 and the active end 130 of the support plate 140 may generally match and substantially co-align. FIG. 7 schematically illustrates that when the insert 120 is removably mounted on the support plate 140, the support plateau 190 may be distanced from the insert lower plateau 310 and the transitional support surface 200 may be distanced from the insert lower transition 290, with the insert lower abutment 330 may be abutting the support rest 205. When there are generally similar therebetween plurality of working ends 110 and the corresponding generally similar therebetween plurality of active ends 130, there may be a generally similar therebetween plurality of insert lower transitions 290 may be distanced from a corresponding plurality of generally similar therebetween transitional support faces 200, while a plurality of generally similar therebetween insert lower abutments 330 may be abutting a plurality of generally similar therebetween support rests 205.

Since when the working end 110 of the insert 120 may be held against another material (not shown) during various kinds and/or modes of operations, supporting the insert 120 directly adjacent to the working end of the insert may increase rigidity and strength of the assembly and therefore of the tool, in general. Additionally, keeping the insert and the support plate separated on the support plateau and the insert lower plateau, and between the plurality of transitional support faces and the plurality of insert lower transitions, while limiting contact to between the plurality of the support rests and the corresponding plurality of insert lower abutments, may assist bending resistance of the insert, as is may be well known in the art.

For the purposes of the original disclosure it is pointed out that all features as can be seen by a man skilled in the art from the present description, the drawings and the claims, even if they are described in specific terms only in connection with certain other features, can be combined both individually and also in any combinations with others of the features or groups of features disclosed here insofar as that has not been expressly excluded or technical aspects make such combinations impossible or meaningless. A comprehensive explicit representation of all conceivable combinations of features is dispensed with here only for the sake of brevity and readability of the description, and shall not be construed as to limit the spirit and scope of the present disclosure.

1. A support plate for an insert which is to be fixed on a tool, the tool comprising at least one seat for at least one insert and at least one support plate, the support plate being provided lower support face removably mounted on the seat, and an upper support face removably carrying the insert, the insert being provided with at least one working end and the support plate being provided with a generally corresponding at least one active end, wherein a support plateau is distanced from an insert lower plateau, and an at least one support rest abuts a generally corresponding insert lower abutment.

2. The support plate of claim 1, wherein a transitional support face is distanced from an insert lower transition.

3. A combination of a support plate and an insert, the support plate being removably mounted on a seat of a tool and the insert being removably mounted on the support plate, the insert being provided with a plurality of generally similar therebetween working ends and the support plate being provided with a plurality of generally similar therebetween active ends, each of the plurality of the working ends is similar and corresponds to a respective one of the plurality of the active ends, wherein a support plateau is distanced from an insert lower plateau, and each of a plurality of support rests abuts ach of a plurality of a generally corresponding insert lower abutments.

4. The combination of claim 3, wherein each of a plurality of transitional support faces is distanced from a corresponding one of a plurality of insert lower transitions.

5. A method for removably mounting at least one insert to a corresponding at least one seat on a tool, the method comprises steps of:
providing at least one corresponding support plate and the at least one insert, the at least one support plate being removably mounted to the at least one seat on the tool;
providing a plurality of generally similar therebetween working ends on the at least one insert and a corresponding plurality of generally similar therebetween active ends on the support plate;
providing a support plateau on the at least one support plate and an insert lower plateau on the at least one insert;
providing a plurality of generally similar therebetween support rests on the at least one support plate and a plurality of generally similar therebetween insert lower abutments each corresponding to one of the plurality of the support rests; wherein
removably mounting the at least one support plate to the at least one seat on the tool;
removably mounting the at least one insert to the removably mounted at least one support plate, so that each of the plurality of
insert lower abutments abuts a corresponding one of the plurality of support rests, and so that the support plateau is distanced from the insert lower support.

6. The method of claim 5, wherein the method comprises an additional step of providing a plurality of generally similar therebetween transitional support faces on an upper support face of the at least one support plate;
providing a plurality of corresponding generally similar therebetween insert lower transitions of the at least one insert, and removably mounting the at least one insert to the at least one support plate, so that each of the plurality of insert lower transitions is distanced from a corresponding support transition faces.
